(19) United States
(12) Patent Application Publication
(10) Pub. No.: US 2020/0332826 A1
(43) Pub. Date: Oct. 22, 2020

(54) INSULATED BOLT CAP WITH REDUNDANT SEAL

(71) Applicant: Thermal Structures, Inc., Corona, CA (US)

(72) Inventors: Gregory Martinez, Riverside, CA (US); Vaughn V. Barnes, Corona Del Mar, CA (US)

(21) Appl. No.: 16/852,307

(22) Filed: Apr. 17, 2020

Related U.S. Application Data
(60) Provisional application No. 62/835,424, filed on Apr. 17, 2019.

(51) Int. Cl. F16B 37/14; F16B 41/00

(52) U.S. Cl. CPC F16B 37/14; F16B 41/005

(57) ABSTRACT

An insulated bolt cap for covering a bolt on an outer plate of an aircraft nacelle is described. The bolt is used to attach an insulation blanket to the outer plate of the aircraft nacelle. The insulation blanket has one or more cavities or depressions with a bolt end exposed in the valley of the cavity. The insulated bolt cap is made of an upper plate coupled with a lower plate, and insulation material therebetween. The underside surface of the lower plate of the insulated bolt cap has an opening sized and dimensioned to mate with the bolt. The top surface of the insulated bolt cap can have a reinforced region with one or more indentations for receiving a tool.

This application claims priority to U.S. Provisional Application Ser. No. 62/835424 filed on Apr. 17, 2019, which is incorporated herein by reference.

### FIELD OF THE INVENTION

The field of the invention is thermal insulation for aircraft and other nacelles.

### BACKGROUND

The following description includes information that may be useful in understanding the present invention. It is not an admission that any of the information provided herein is prior art or relevant to the presently claimed invention, or that any publication specifically or implicitly referenced is prior art.

Aircraft nacelles are streamline housings positioned about a jet, diesel or other engine. For noise and heat abatement, nacelle plates can be fitted with thermal insulation blankets. Such blankets are typically made of metal foils filled with ceramic fiber. Bolts holding the insulation blankets to the nacelle plates are usually kept in place at least partially using a high temperature adhesive. However, because of the high temperatures, extreme vibration, and air pressures of up to 600 PSI, the adhesive can fail, and the bolts can come loose or fall out.

Thus, there is still a need to provide apparatus and methods that prevent the insulation-retaining bolts in a nacelle from coming loose or falling out, without also compromising the thermal protection afforded by the insulation material.

All publications cited herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which an insulated bolt cap comprises an upper plate coupled with a lower plate, and a compression material disposed on an underside surface of the lower plate. Between the upper and lower plates is an interior space with an insulation material. The underside surface of the lower plate also has an opening sized and dimensioned to receive an end of a bolt, such as the bolt holding an insulating blanket to an outer plate of an aircraft nacelle.

In some embodiments, a compression material is also included on an underside surface of the upper plate. The compression material can comprise silicon.

In other aspects of some embodiments, the lower plate can comprise a bowl. The upper plate is sized and dimensioned to cover the bowl to create an interior space between the upper plate and the lower plate. The upper plate can be a substantially flat circular disk, a concave or convex disk, or any other shape suitable for creating an enclosed space when coupled with the upper plate.

In yet other aspects, the upper plate has a reinforced region. The reinforced region can have one or more indentations spaced apart, and configured to receive prongs of a tightening tool.

From a methods perspective, the inventive subject matter provides a method of insulating an end of a bolt, in which the insulated bolt cap described above is attached to a bolt end. For example, contemplated methods can include the steps of (i) providing a cavity in a side of an insulating blanket on an outer plate of an aircraft nacelle, the cavity having a bolt; (ii) providing an insulated bolt cap comprising an upper plate coupled with a lower plate and an insulation material disposed in a space between the upper plate and the lower plate, wherein an underside surface of the lower plate has a threaded opening sized and dimensioned to receive the bolt; and (iii) screwing the threaded opening onto the bolt. In some embodiments, the step of screwing the insulated bolt cap onto the bolt comprises inserting a tool into one or more indentations on the upper plate and rotating the tool to rotate the insulated bolt cap.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of an insulated outer plate of an aircraft nacelle.

FIG. 2 is a close-up view of the outer plate of FIG. 1 and a bottom perspective view of an insulated bolt cap.

FIG. 3 is a close-up view of the insulated bolt cap in FIG. 3 being placed in a recess of the outer plate.

FIG. 4 is a close-up view of the insulated bolt cap in FIG. 3 placed inside the recess of the outer plate.

FIG. 5 is a close-up view of a tool being used to rotate the insulated bolt cap in FIG. 3 onto the bolt in the recess of the outer plate.

FIG. 6 is a perspective view of the insulated bolt cap of FIG. 3 shown in a flush installation on the outer plate.

FIG. 7 is an exploded view of another embodiment of an insulated bolt cap and an insulated panel.

FIG. 8 is a partially exploded view of the insulated bolt cap and the insulated panel of FIG. 7.

FIG. 9 is a perspective view of the insulated bolt cap and an insulated panel of FIG. 7 with the insulated bolt cap screwed onto the bolt of the insulated panel.

FIG. 10 is a perspective cross-sectional view of the insulated bolt cap and the insulated panel of FIG. 7.

FIG. 11 is another perspective cross-sectional view of the insulated bolt cap and the insulated panel of FIG. 7.

FIG. 12 is a side cross-sectional view of the insulated bolt cap and the insulated panel of FIG. 7.

FIG. 13 is a side cross-sectional view of another embodiment of an insulated bolt cap.

FIG. 14 is a side view of the insulated bolt cap of FIG. 13.

FIG. 15 is a top view of the insulated bolt cap of FIG. 13.

FIG. 16 is an exploded view of the insulated bolt cap of FIG. 13.

FIG. 17 is a top perspective view of the bottom tray and nut of the insulated bolt cap of FIG. 13.

FIG. 18 is a top perspective view of the nut of the insulated bolt cap of FIG. 13.

### DETAILED DESCRIPTION

One should appreciate that the insulated bolt caps described herein provide many advantageous technical effects such as insulating aircraft nacelle and securing insulation blankets to outer plates of aircraft nacelle.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

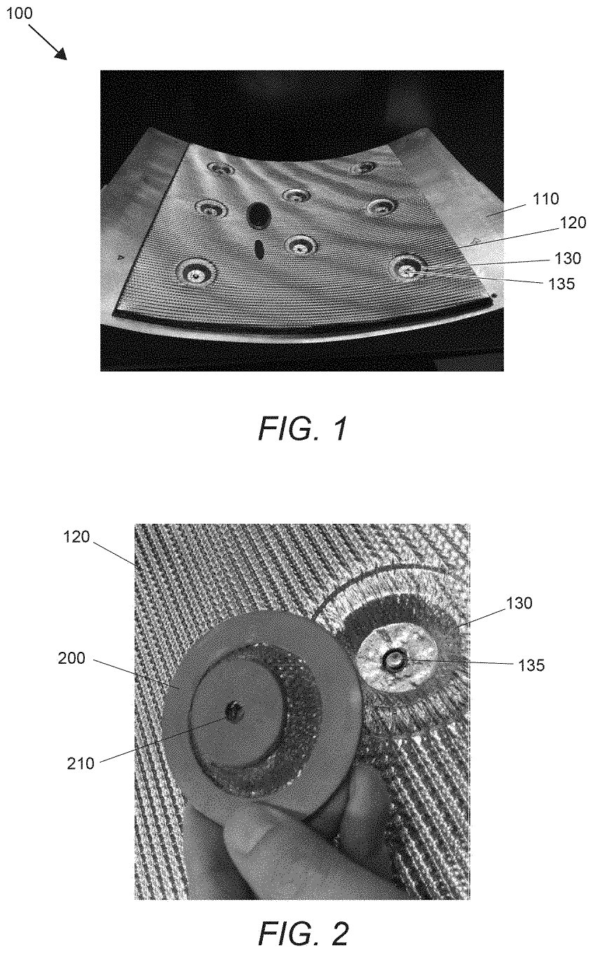

FIG. 1 is a perspective view of an outer plate 110 of an aircraft nacelle 100, upon which is mounted an insulation blanket 120. Insulation blanket 120 has one or more cavities 130 with an end of a bolt 135 exposed. Bolt 135 is used to fasten insulation blanket 120 to outer plate 110 of nacelle 100.

Outer plate 110 is typically made of aluminum but could be a steel alloy or other material. Insulation blanket 120 can comprise an aluminum or other foil covering disposed about ceramic fibers or other thermally insulating material(s).

Inside the perimeter of each cavity 130 is a depressed region comprising a ridge surrounding a valley floor, and a tapered side connecting the ridge and the floor. The ridge, floor and tapered side of the cavity each assist in sealing when an insulated bolt cap is positioned inside the cavity 130 and fastened to the bolt. There is a hole in the middle of the alley floor, through which the headed end of a bolt 135 is disposed.

FIG. 2 is a close-up view of an underside surface of an insulated bolt cap 200 near cavity 130. The underside surface of insulated bolt cap 200 is shaped and configured to fit and nest in cavity 130. Insulated bolt cap 200 has a threaded opening 210, such as a nut, that is sized and dimensioned to receive bolt 135 and mate with the threads on bolt 135.

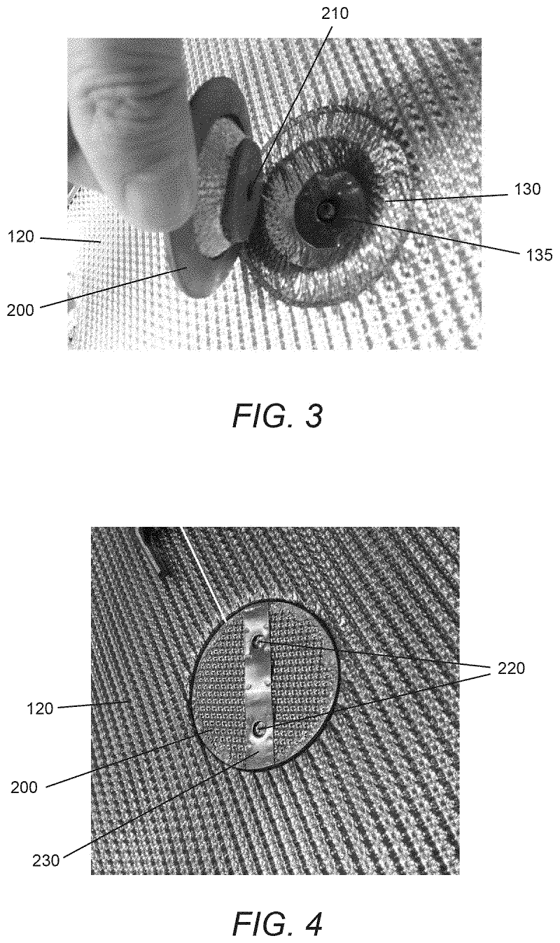

FIG. 3 is a close-up view of the insulated bolt cap 200 being held by a person's fingers while being inserted into cavity 130.

FIG. 4 is a close-up view of the insulated bolt cap 200 seated in cavity 130. The upper surface of insulated bolt cap 200 has a reinforcement region 230 with two indentations 220 for inserting a tool 500. Reinforcement region 230 structurally supports the top of insulated bolt cap 200 from buckling or distorting when prongs of a tool 500 are inserted into indentations 220. The upper surface can be lined with a foil that matches the foil of the top layer of insulation blanket 120.

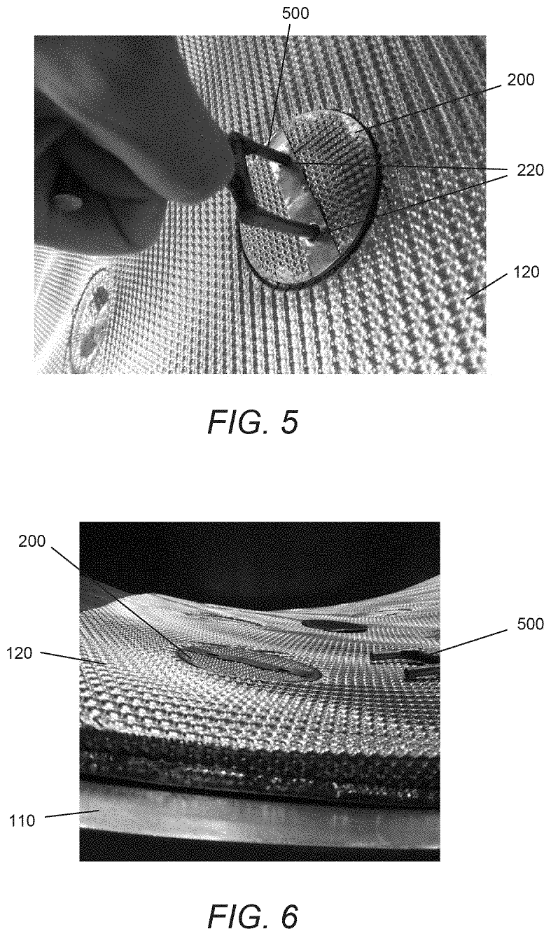

FIG. 5 is a close-up view of a tool 500 with prongs inserted into indentations 220. Tool 500 can be used to rotate and screw insulated bolt cap 200 onto bolt 135.

FIG. 6 is a side perspective view of insulated bolt cap 200 screwed onto bolt 135 and seated inside cavity 130 and flush with the top surface of insulation blanket 120 of outer plate 110.

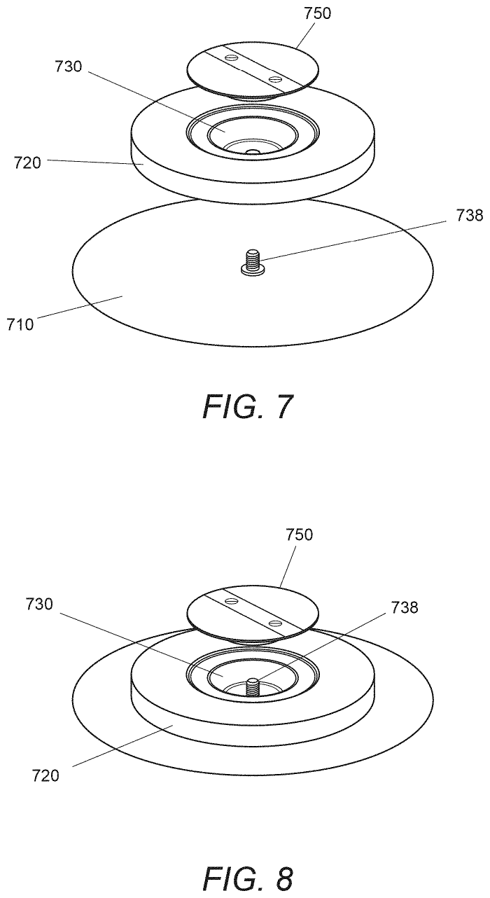

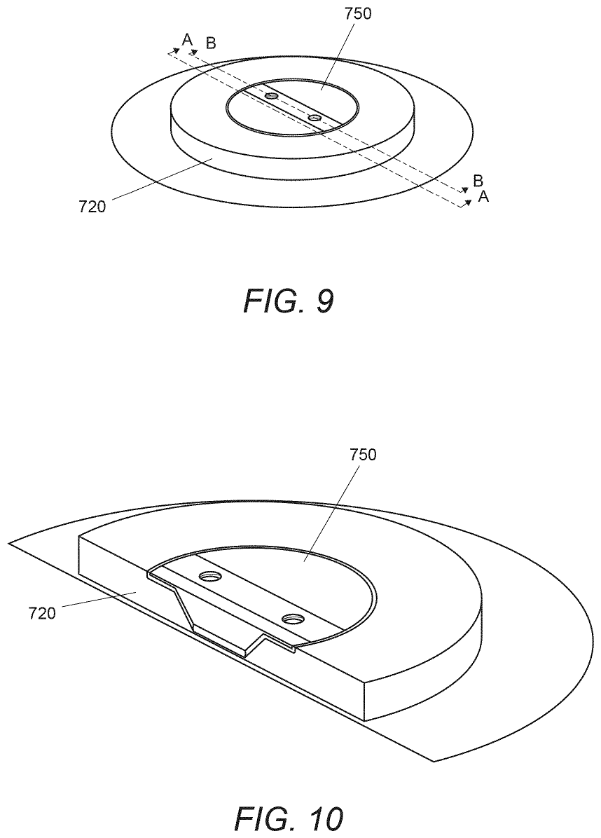

FIG. 7 is an exploded view of an insulated bolt cap 750 that fits inside cavity 730 of insulation blanket 720 fastened to panel 710 via bolt 735. Insulated bolt cap 750 has a threaded opening like insulated bolt cap 200 for mating with bolt 735. FIG. 8 is a partially exploded view of insulated bolt cap 750 about to be seated inside cavity 730 of insulation blanket 720. FIG. 9 is a perspective view of insulated bolt cap 750 seated inside cavity 730 of insulation blanket 720 and screwed onto bolt 735.

FIG. 10 is a perspective cross-sectional view of insulated bolt cap 750 and the insulated blanket 720 along line A-A in FIG. 9 showing the outer foil layers and the inner insulation layers.

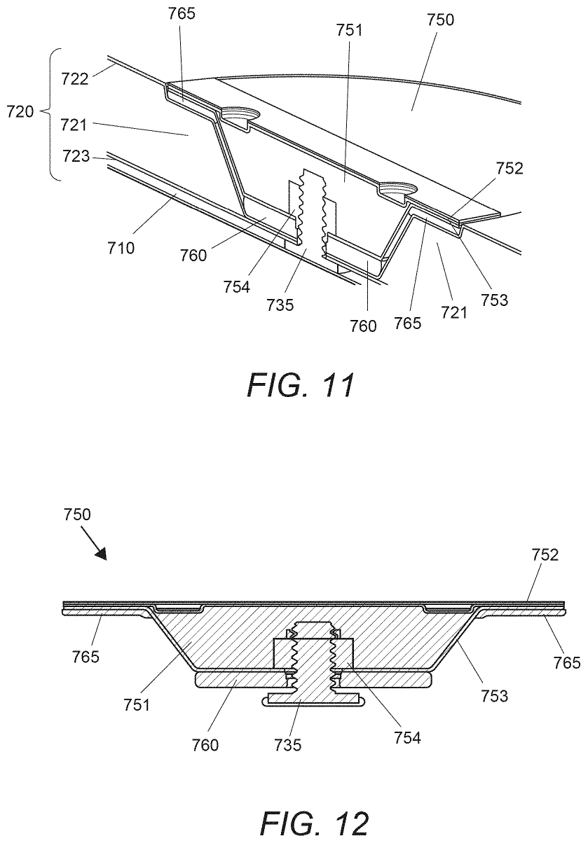

FIG. 11 is another perspective cross-sectional view of insulated bolt cap 735 and the insulated blanket 720 along line B-B in FIG. 9. Insulated blanket 720 comprises a top foil layer 722, a bottom foil layer 723, and an insulation material 721 disposed between foil layers 722 and 723. Likewise, insulated bolt cap 750 has two outer foil layers (e.g., upper plate 752, lower plate 753), and an insulation material 751 between the foil layers. In some applications, insulation material 751 and insulation material 721 are made of the same material.

Insulated bolt cap 750 also has a threaded opening 754 that is configured to mate with the threads on bolt 735. A compression material 760 and 765 is placed on the underside surfaces of the lower plate and upper plate, respectively. A compression material 760 is placed on the underside surface of the lower plate and compression material 765 is placed on the underside surface of the outer flange of the lower and upper plates. The compression material can comprise sheets of silicone, rubber, or other compressible materials. The compressible properties of the compression material aids in sealing the upper and lower plate against the slanted and horizontal inner walls of the cavities, and also act as lock washers to aid in preventing the bolts from detaching from their respective insulated bolt caps.

FIG. 12 is a side cross sectional view of the insulated bolt cap 750 removed from the cavity 730 and insulating blanket 720.

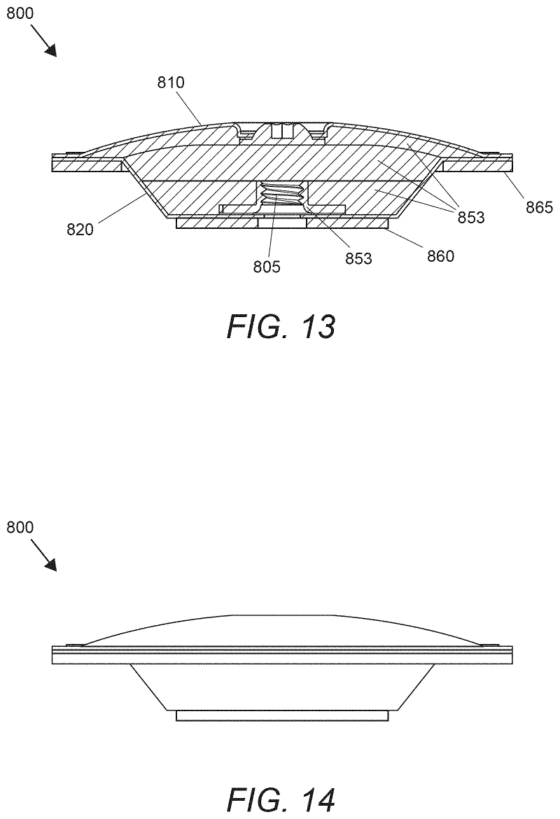

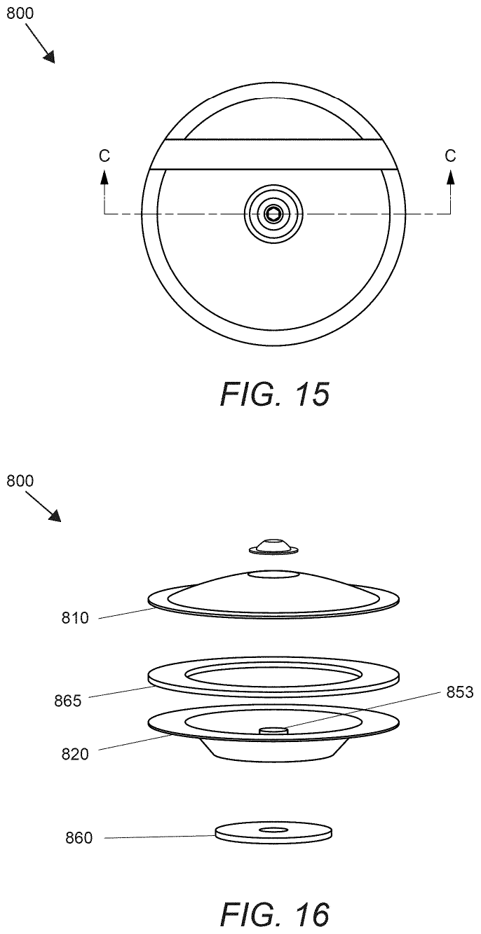

FIG. 13 is a side cross-sectional view of another embodiment of an insulated bolt cap 800 along line C-C in FIG. 15. Insulated bolt cap 800 has an upper plate 810 with a concave or dome shape coupled with a lower plate 820. Lower plate 820 has a threaded opening 853 for receiving a bolt 805. Between upper plate 810 and lower plate 820 is an insulating material 851. A compression material 860 and 865 is placed on the underside surface of lower plate, and optionally, the underside of the outer flange on the upper and lower plates. FIG. 14 is a side view of insulated bolt cap 800. FIG. 15 is a top view of insulated bolt cap 800.

FIG. 16 is an exploded view of insulated bolt cap 800 comprising an upper plate 810, a lower plate 820, compression material 860, 865, and threaded opening 853 on the underside surface of lower plate 820. Upper plate 810 is positioned parallel to lower plate 820. Upper plate 810 and lower plate 820 can be made of a metal foil or a similar material as the insulation blanket. Upper plate 810 and lower plate 820 can also be made of a rigid metal.

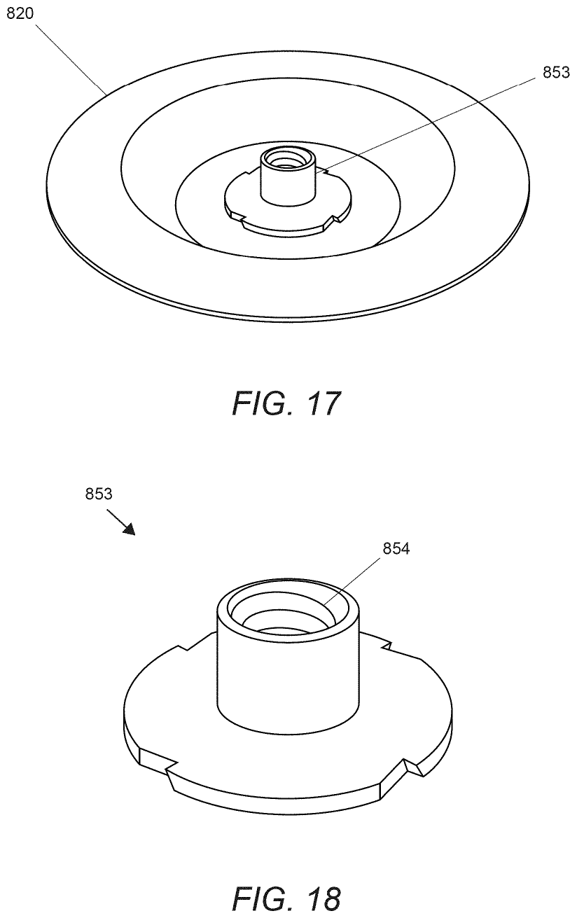

FIG. 17 is a top perspective view of lower plate 820 showing threaded opening 853. Lower plate 820 forms a circular bowl shape with tapered sides or perimeter, a valley floor, and a ridge that surrounds the valley floor. The ridge extends outward forming an outer annular flange.

FIG. 18 is a top perspective view of the threaded opening 853. Opening 853 can be a nut that is fastened to an opening in the lower plate 820. Opening 853 can also be an integral feature of the wall of lower plate 820.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. An insulated bolt cap comprising:
an upper plate coupled with a lower plate to form an interior space;
an insulation material disposed in the interior space;
wherein an underside surface of the lower plate has an opening sized and dimensioned to receive a bolt; and
a compression material disposed on an underside of the lower plate.

2. The bolt cap of claim 1, wherein the compression material comprises silicone.

3. The bolt cap of claim 1, further comprising a second compression material coupled to an underside surface of the upper plate.

4. The bolt cap of claim 1, wherein the upper plate is parallel to the lower plate.

5. The bolt cap of claim 1, wherein the upper plate is a substantially flat circular disk.

6. The bolt cap of claim 1, wherein the upper plate is a concave disk.

7. The bolt cap of claim 1, wherein the lower plate comprises a circular bowl having a tapered perimeter and a flanged outer edge.

8. The bolt cap of claim 1, wherein the insulation material has a tapered perimeter.

9. The bolt cap of claim 1, wherein the upper plate has a reinforced region.

10. The bolt cap of claim 9, wherein the reinforced region has at least first and second spaced apart indentations, configured to receive prongs of a tightening tool.

11. The bolt cap of claim 1, wherein the upper plate has at least one indentation configured to receive a prong of a tightening tool.

12. The bolt cap of claim 1, wherein the opening comprises a nut having internal threads configured to mate with external threads on the bolt.

13. A method of insulating an end of a bolt that couples an insulating blanket to a plate of a nacelle, the method comprising:
providing a cavity in a side of the insulating blanket, the cavity having a bolt;
providing an insulated bolt cap comprising an upper plate coupled with a lower plate and an insulation material disposed in a space between the upper plate and the lower plate, wherein an underside surface of the lower plate has a threaded opening sized and dimensioned to receive the bolt; and
screwing the threaded opening onto the bolt.

14. The method of claim 13, wherein the upper plate and lower plate comprise a metal foil.

15. The method of claim 13, wherein the shape of the underside surface of the insulated bolt cap is configured to nest with the shape of the cavity.

16. The method of claim 13, wherein the upper plate has one or more indentations.

17. The method of claim 16, wherein the step of screwing the insulated bolt cap onto the bolt comprises inserting a tool into the one or more indentations and rotating the tool to rotate the insulated bolt cap.

18. The method of claim 13, wherein the insulating blanket and the insulation material in the space between the upper plate and the lower plate are made of the same material.
